(19) United States
(12) Patent Application Publication
(10) Pub. No.: US 2026/0353217 A1
(43) Pub. Date: Nov. 5, 2026

(54) STRUCTURE FOR SUPPORTING LAYER 1/LAYER 2-BASED INTER-CELL MOVEMENT IN NEXT-GENERATION MOBILE COMMUNICATION SYSTEM, AND SIGNALING METHOD AND DEVICE FOR SAME

(71) Applicant: Samsung Electronics Co., Ltd., Suwon-si, Gyeonggi-do (KR)

(72) Inventors: Seungri JIN, Suwon-si (KR); Anil AGIWAL, Suwon-si (KR)

(21) Appl. No.: 19/099,245

(22) PCT Filed: Aug. 2, 2023
(86) PCT No.: PCT/KR2023/011342

§ 371 Date: Jan. 28, 2025

(30) Foreign Application Priority Data
Aug. 4, 2023 (KR) 10-2022-0097358

(51) Int. Cl. H04W 36/08; H04W 36/00; H04W 36/36; H04W 72/231; H04W 74/0833

(52) U.S. Cl. CPC H04W 36/08; H04W 36/0061; H04W 36/36; H04W 72/231; H04W 74/0833

(57) ABSTRACT

The present disclosure relates to a 5G or 6G communication system for supporting a higher data transmission rate. According to the present disclosure, a method performed by a terminal in a wireless communication system comprises the steps of: receiving, from a base station, a radio resource control (RRC) message including a configuration for candidates of a target cell for a handover; receiving, from the base station, a medium access control (MAC) control element (CE) including information indicating one target cell among the candidates of the target cell; performing a handover to the target cell indicated by the MAC CE; and transmitting a message indicating completion of the handover to the base station.

### CROSS-REFERENCE TO RELATED APPLICATION(S)

This application is a U.S. National Stage application under 35 U.S.C. § 371 of an International application number PCT/KR2023/011342, filed on Aug. 2, 2023, which is based on and claims priority of a Korean patent application number 10-2022-0097358, filed on Aug. 4, 2022, in the Korean Intellectual Property Office, the disclosure of which is incorporated by reference herein in its entirety.

### TECHNICAL FIELD

The disclosure relates to a mobile communication system and, more particularly, to a structure, signaling method, and apparatus for supporting inter-cell mobility in a mobile communication system.

### BACKGROUND ART

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

### DISCLOSURE

### Technical Problem

The disclosure enables a terminal to measure and report beams belonging to other cells while receiving a service from the current serving cell through a specific beam, and to perform cell switching to a neighbor cell if the beam of the neighbor cell is better. The disclosure aims to resolve the inefficient portion of the legacy cell switch procedure requiring a long delay time, and in particular, to reduce the delay time of handover to a neighbor cell, it resolves the overall operation by delivering related configuration information in advance and indicating this through L1/L2 signaling.

### Technical Solution

To solve the above problem, the disclosure provides a method performed by a terminal in a wireless communication system. The method may include: receiving a radio resource control (RRC) message including configurations of candidate target cells for a handover from a base station; receiving a medium access control (MAC) control element (CE) including information indicating one target cell among the candidate target cells from the base station; performing a handover to the target cell indicated by the MAC CE; and transmitting, to the base station, an RRC complete message indicating completion of the handover.

In addition, to solve the above problem, the disclosure provides a method performed by a base station in a wireless communication system. The method may include: transmitting a radio resource control (RRC) message including configurations of candidate target cells for a handover to a terminal; transmitting a medium access control (MAC) control element (CE) including information indicating one target cell among the candidate target cells to the terminal; and receiving, from the terminal, an RRC complete message indicating completion of the handover in case that the terminal is handed over to the target cell indicated by the MAC CE.

In addition, to solve the above problem, the disclosure provides a terminal in a wireless communication system. The terminal may include: a transceiver; and a controller connected to the transceiver, wherein the controller may be configured to: receive a radio resource control (RRC) message including configurations of candidate target cells for a handover from a base station; receive a medium access control (MAC) control element (CE) including information indicating one target cell among the candidate target cells from the base station; perform a handover to the target cell indicated by the MAC CE; and transmit, to the base station, an RRC complete message indicating completion of the handover.

In addition, to solve the above problem, the disclosure provides a base station in a wireless communication system. The base station may include: a transceiver; and a controller connected to the transceiver, wherein the controller may be configured to: transmit a radio resource control (RRC) message including configurations of candidate target cells for a handover to a terminal; transmit a medium access control (MAC) control element (CE) including information indicating one target cell among the candidate target cells to the terminal; and receive, from the terminal, an RRC complete message indicating completion of the handover in case that the terminal is handed over to the target cell indicated by the MAC CE.

### Advantageous Effects

By using the layer 1 measurement and reporting method for layer 1 and layer 2 (L1/L2)-based beam switch and handover proposed in this disclosure, the terminal may determine handover operation through beam measurements on a cell other than the serving cell. In addition, according to the disclosure, the terminal may support beam switching and handover operation toward a neighbor cell through layer 1 based beam measurement, and the delay time is reduced compared to the legacy procedure, so that the terminal may transmit and receive data after changing the beam together with the handover to another cell.

### DESCRIPTION OF DRAWINGS

FIG. 1 is a diagram illustrating the architecture of a next-generation mobile communication system to which the disclosure is applied.

FIG. 2 is a diagram showing the structure of radio protocols in the next-generation mobile communication system to which the disclosure may be applied.

FIG. 3 is a diagram illustrating the architecture of another next-generation mobile communication system to which the disclosure may be applied.

FIG. 4 is a diagram illustrating a scenario for inter-cell beam management referred to in the disclosure, in which while remaining in the connected state with the serving cell, the UE transmits and receives data through a beam of a transmission/reception point (TRP) of a neighbor cell that supports L1/L2-based beam switching.

FIG. 5A is a diagram illustrating a scenario in which the UE transmits and receives data after performing serving cell and beam change toward a TRP of a cell that supports L1/L2-based beam switching, as an embodiment considered in the disclosure.

FIG. 5B is a diagram illustrating a scenario in which the UE transmits and receives data after performing serving cell and beam change toward a TRP of a cell that supports L1/L2-based beam switching, as an embodiment considered in the disclosure.

FIG. 6 is a diagram illustrating the overall operation of inter-cell beam management of FIG. 4 referred to in the disclosure.

FIG. 7A is a diagram illustrating a method for configuring candidate neighbor cells that support L1/L2 inter-cell handover proposed in the disclosure.

FIG. 7B is a diagram illustrating a method for configuring candidate neighbor cells that support L1/L2 inter-cell handover proposed in the disclosure.

FIG. 8A is a MAC CE and DCI format for L1/L2-based beam switching and handover proposed in the disclosure.

FIG. 8B is a MAC CE and DCI format for L1/L2-based beam switching and handover proposed in the disclosure.

FIG. 9 is a diagram illustrating the overall operation of performing handover after applying L1/L2 inter-cell beam management as Embodiment 1 applied to the disclosure.

FIG. 10 is a diagram illustrating the overall operation of performing L1/L2 inter-cell handover as Embodiment 2 applied to the disclosure.

FIG. 11 is a diagram illustrating UE operations that indicate L1/L2 inter-cell beam switch and handover with MAC CE only in the overall UE operation for performing L1/L2-based beam switch and handover, applied to embodiments of the disclosure.

FIG. 12 is a diagram illustrating UE operations for indicating L1/L2 inter-cell beam switch and handover with MAC CE and DCI in the overall UE operation for performing L1/L2-based beam switch and handover, applied to embodiments of the disclosure.

FIG. 13 is a diagram illustrating base station operations applied to embodiments of the disclosure.

FIG. 14 is a block diagram showing the internal structure of a UE to which the disclosure is applied.

FIG. 15 is a block diagram showing the structure of a base station according to the disclosure.

### MODE FOR DISCLOSURE

Hereinafter, the operating principle of the present disclosure will be described in detail with reference to the accompanying drawings. In explaining the disclosure below, descriptions of well-known functions and structures incorporated herein may be omitted to avoid obscuring the subject matter of the disclosure. The terms described below are defined in consideration of their functions in the disclosure, and these may vary depending on the intention of the user, the operator, or the custom. Hence, their meanings should be determined based on the overall contents of this specification. Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

For convenience of description, the disclosure uses terms and names defined in the standards for 3GPP LTE (3rd Generation Partnership Project Long Term Evolution). However, the disclosure is not limited by the above terms and names, and can be equally applied to systems conforming to other standards.

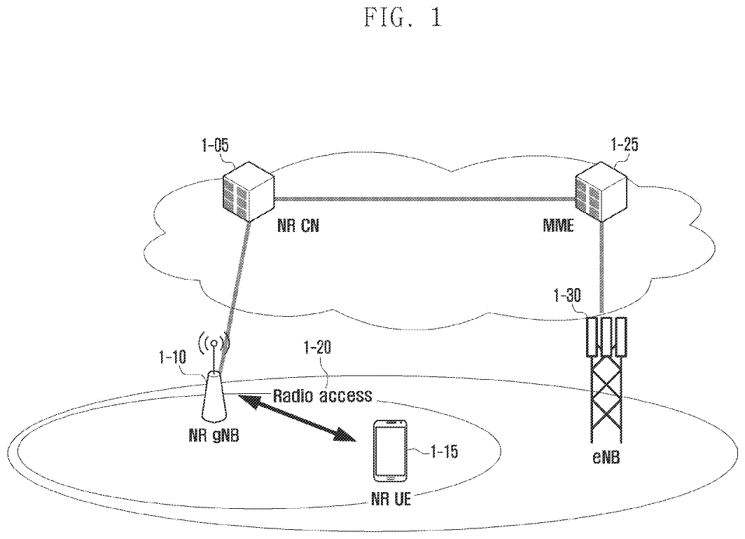

FIG. 1 is a diagram illustrating the architecture of a next-generation mobile communication system to which the disclosure is applied.

With reference to FIG. 1, as shown, the radio access network of the next-generation mobile communication system may be composed of a new radio node B (NR NB, or next generation base station) 1-10 and a new radio core network (NR CN, or next generation core network (NG CN)) 1-05. A new radio user equipment (hereinafter, NR UE or terminal) 1-15 may connect to an external network through the NR NB 1-10 and the NR CN 1-05.

In FIG. 1, the NR NB 1-10 may correspond to an evolved node B (eNB) of the legacy LTE system. The NR NB 1-10 may be connected to the NR UE 1-15 through a radio channel, and it can provide a more superior service than that of the legacy node B. All user traffic may be serviced through shared channels in the next-generation mobile communication system. Hence, there may be a need for an entity that performs scheduling by collecting status information, such as buffer states, available transmission power states, and channel states of individual UEs, and the NR NB 1-10 may take charge of this. One NR NB 1-10 controls a plurality of cells in typical situations. To implement ultra-high-speed data transmission compared with current LTE, a bandwidth beyond the legacy maximum bandwidth may be utilized. Also, a beamforming technology may be additionally used with orthogonal frequency division multiplexing (OFDM) serving as a radio access technology. Further, an adaptive modulation and coding (AMC) scheme determining a modulation scheme and channel coding rate to match the channel state of the UE may be applied. The NR CN 1-05 may perform functions such as mobility support, bearer configuration, and quality of service (QoS) configuration. The NR CN 1-05 is an entity taking charge of not only mobility management but also various control functions for the UE 1-15, and may be connected to a plurality of base stations. In addition, the next-generation mobile communication system may interwork with the legacy LTE system, and the NR CN may be connected to the MME 1-25 through a network interface. The MME is connected to an eNB 1-30 being a legacy base station.

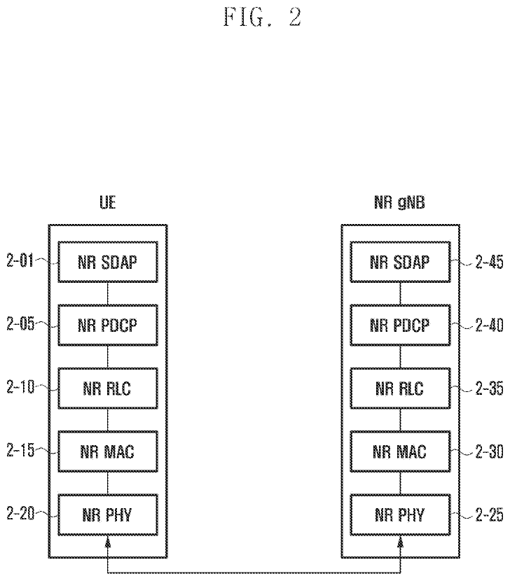

FIG. 2 is a diagram showing the structure of radio protocols in the next-generation mobile communication system to which the disclosure may be applied.

With reference to FIG. 2, in a UE or an NR gNB, the radio protocols of the next-generation mobile communication system may include NR SDAP 2-01 or 2-45, NR PDCP 2-05 or 2-40, NR RLC 2-10 or 2-35, and NR MAC 2-15 or 2-30.

The main functions of the NR SDAP 2-01 or 2-45 may include some of the following functions.
User data transfer function (transfer of user plane data)
Mapping function between QoS flows and data bearers for uplink and downlink (mapping between a QoS flow and a DRB for both DL and UL)
QoS flow ID marking function for uplink and downlink (marking QoS flow ID in both DL packets and UL packets)
Function of mapping reflective QoS flow to data bearer for uplink SDAP PDUs (reflective QoS flow to DRB mapping for the UL SDAP PDUs)

With respect to the SDAP entity, the UE may be configured with, through a RRC message, whether to use a header of the SDAP entity or whether to use a function of the SDAP entity for each PDCP entity, bearer, or logical channel. Also, if a SDAP header is configured, a NAS reflective QoS 1-bit indication and AS reflective QoS 1-bit indication of the SDAP header may instruct the UE to update or reconfigure the mapping information between QoS flows and data bearers for the uplink and downlink. The SDAP header may include QoS flow ID information indicating the QoS. The QoS information may be used as data processing priority and scheduling information for supporting smooth services.

The main function of the NR PDCP 2-05 or 2-40 may include some of the following functions.
Header compression and decompression function (header compression and decompression: ROHC only)
User data transfer function (transfer of user data)
In-sequence delivery function (in-sequence delivery of upper layer PDUs)
Out-of-sequence delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUs)
Cipher and decipher function (ciphering and deciphering)
Timer-based SDU discard function (timer-based SDU discard in uplink)

In the above description, the reordering function of the NR PDCP entity may indicate reordering of PDCP PDUs received from a lower layer in order based on the PDCP sequence number (SN), and may include delivering data to an upper layer in reordered sequence, directly delivering data without considering the order, recording lost PDCP PDUs through reordering, reporting the status of lost PDCP PDUs to the transmitting side, or requesting retransmission of the lost PDCP PDUs.

The main function of the NR RLC 2-10 or 2-35 may include some of the following functions.
Data transfer function (transfer of upper layer PDUs)
In-sequence delivery function (in-sequence delivery of upper layer PDUs)
Out-of-sequence delivery function (out-of-sequence delivery of upper layer PDUs)
ARQ function (error correction through ARQ)
Concatenation, segmentation and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
RLC SDU discard function (RLC SDU discard)
RLC re-establishment function (RLC re-establishment)

In the above description, in-sequence delivery of the NR RLC entity may indicate in-sequence delivery of RLC SDUs received from a lower layer to an upper layer, and may include: reassembly and delivery of RLC SDUs when several RLC SDUs belonging to one original RLC SDU are received after segmentation; reordering of received RLC PDUs based on the RLC sequence number (SN) or the PDCP SN; recording lost RLC PDUs through reordering; reporting the status of the lost RLC PDUs to the transmitting side; and requesting retransmission of the lost RLC PDUs. If there is a lost RLC SDU, in-sequence delivery of the NR RLC entity may include in-sequence delivery of only RLC SDUs before the lost RLC SDU to an upper layer; or, although there is a lost RLC SDU, if a specified timer has expired, in-sequence delivery thereof may include in-sequence delivery of all the RLC SDUs received before the starting of the timer to an upper layer; or, although there is a lost RLC SDU, if a specified timer has expired, in-sequence delivery thereof may include in-sequence delivery of all the RLC SDUs received up to now to an upper layer. In addition, the NR RLC entity may process RLC PDUs in the order of reception regardless of the order of the sequence number, and transfer them to the NR PDCP entity in an out-of-sequence delivery manner. In case of receiving a segment, the NR RLC entity may reconstruct one whole RLC PDU from segments stored in the buffer or received later, and transfer it to the NR PDCP entity. The NR RLC layer may not include a concatenation function, which may be performed by the NR MAC layer or may be replaced with a multiplexing function of the NR MAC layer.

In the above description, out-of-sequence delivery of the NR RLC entity may indicate a function of transferring RLC SDUs received from a lower layer directly to a higher layer regardless of their order. If several RLC SDUs belonging to one original RLC SDU are received after segmentation, out-of-sequence delivery of the NR RLC entity may include reassembly and delivery of the RLC SDUs. Out-of-sequence delivery thereof may include storing the RLC SNs or PDCP SNs of received RLC PDUs and ordering them to record lost RLC PDUs.

The NR MAC 2-15 or 2-30 may be connected to several NR RLC entities configured in one UE, and the main function of the NR MAC may include some of the following functions.
Mapping function (mapping between logical channels and transport channels)
Multiplexing and demultiplexing function (multiplexing/demultiplexing of MAC SDUs)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

The NR PHY 2-20 or 2-25 may compose OFDM symbols from higher layer data through channel coding and modulation and transmit them through a radio channel, or may demodulate and channel-decode OFDM symbols received through a radio channel and forward the result to a higher layer.

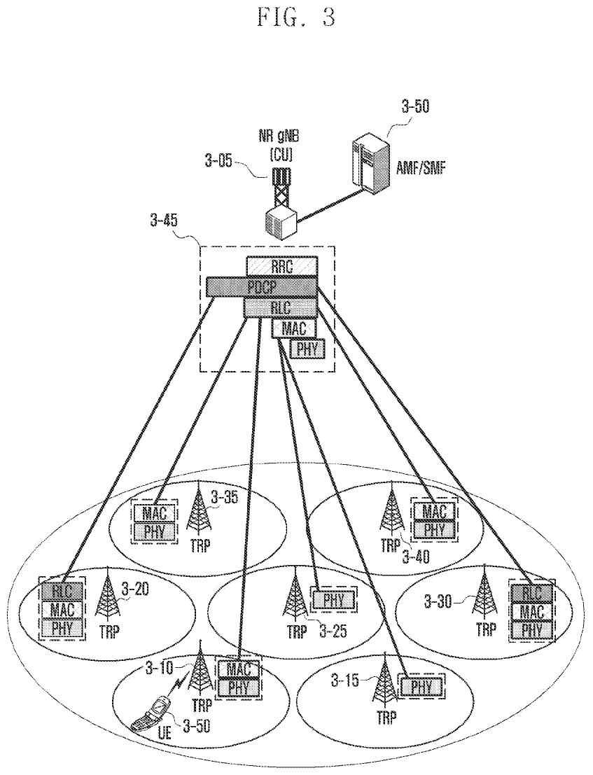

FIG. 3 is a diagram illustrating the architecture of another next-generation mobile communication system to which the disclosure may be applied.

Referring to FIG. 3, the cell served by a NR gNB 3-05 operating based on beams may be composed of multiple transmission reception points (TRPs) 3-10, 3-15, 3-20, 3-25, 3-30, 3-35, 3-40. TRPs 3-10 to 3-40 represent a block with some functions for transmitting and receiving physical signals separated from the legacy NR base station (eNB), and are composed of multiple antennas. The NR gNB 3-05 may also be referred to as a central unit (CU) and the TRP may also be referred to as a distributed unit (DU). The functions of the NR gNB 3-05 and TRP may be configured by extracting some layers from the layers of PDCP/RLC/MAC/PHY as indicated by 3-45. That is, the TRP 3-15 or 3-25 may include only the PHY layer to perform the function of the corresponding layer, the TRP 3-10, 3-35 or 3-40 may include only the PHY layer and the MAC layer to perform the function of the corresponding layers, and the TRP 3-20 or 3-30 may include only the PHY layer, the MAC layer, and the RLC layer to perform the function of the corresponding layers. In particular, the TRPs 3-10 to 3-40 may use a beamforming technique to transmit and receive data by generating narrow beams in various directions using multiple transmit/receive antennas. The UE 3-50 connects to the NR gNB 3-05 and an external network through the TRPs 3-10 to 3-40. The NR gNB 3-05 collects status information of UEs such as buffer state, available transmission power state, and channel state to provide services to the users, and schedules them to support connections between the UEs and the core network (CN), particularly the AMF/SMF 3-50.

The TRP in the disclosure may be assumed to have a structure 3-15 or 3-25 that includes only the PHY layer and performs the function of the corresponding layer.

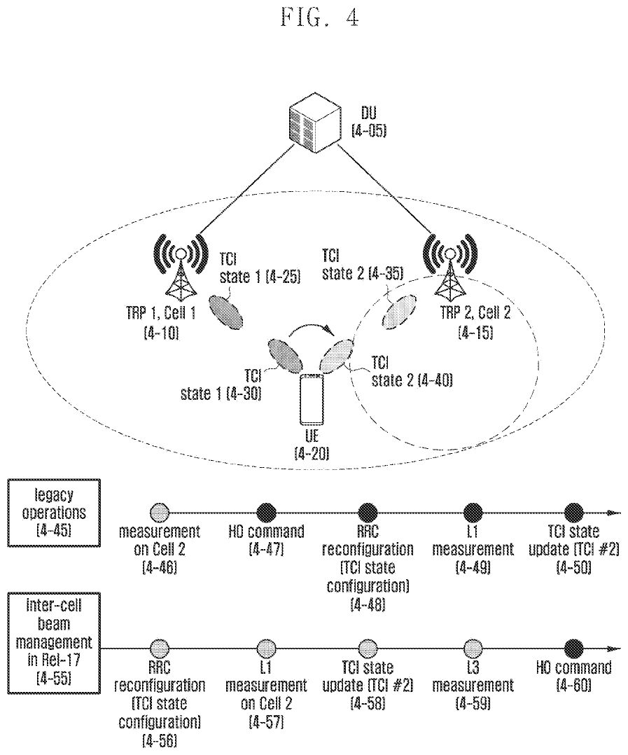

FIG. 4 is a diagram illustrating a scenario for inter-cell beam management referred to in the disclosure, in which while remaining in the connected state with the serving cell, the UE transmits and receives data through a beam of a transmission/reception point (TRP) of a neighbor cell that supports L1/L2-based beam switching.

Although this drawing describes a case where multiple cells (TRP1-Cell1 4-10, TRP2-Cell2 4-15) are present within one distributed unit (DU) 4-05, the overall content of this disclosure may also be applied to the inter-DU case (each DU constitutes one TRP-Cell). Additionally, throughout the disclosure, a cell (TRP 2, Cell 2) that is not a serving cell supporting L1/L2-based mobility (beam switch and serving cell change) may be referred to interchangeably as a neighbor cell, a non-serving cell, an additional cell with a PCI different from the serving cell, or the like.

In the legacy UE beam switch procedure (4-45), the UE 4-20 may transmit and receive data in the connected state through TRP 1 (4-10) of serving cell 1, and the beam of the UE may be aligned to TCI state 1 being the optimal beam (4-25, 4-30). At this stage, the UE may receive, through RRC configuration information from serving cell 1 (4-10), configuration information for L3 channel measurement (radio resource management (RRM)) as to an additional cell with a different PCI from the serving cell (TRP 2-Cell 2, 4-15), and may perform L3 measurement operation on the corresponding frequency and cell (4-46).

Thereafter, serving cell 1 (TRP 1-Cell 1, 4-10) may command a handover toward cell 2 (TRP 2-Cell 2, 4-15) based on the reported measurement value (4-47), and after the handover is completed, additional RRC configuration information may be transmitted to the UE 4-20 through TRP 2-Cell 2 (4-15) (4-48). The RRC configuration information may include at least one of UL/DL configuration information in cell 2 or L1 measurement-related configuration (CSI-RS measurement and reporting), and may include, in particular, TCI state configuration information for PDCCH and PDSCH channels. The UE may perform L1 measurement according to the configuration (4-49), and the base station may update the TCI state through L1/L2 signaling according to the measurement report (4-50). Here, TCI state 2 (4-40) being the optimal beam may be indicated. In this case, the serving cell is Cell 1 before the handover, and Cell 2 becomes the serving cell after the handover. That is, many procedures and time may be required even after the handover until the optimal beam is indicated.

Unlike the above legacy UE beam switch procedure (4-45), the improved beam switch technique (4-55) considered in the disclosure is as follows.

Serving cell 1 (4-10) may transmit a beam configuration associated with an additional cell with a different PCI from the serving cell (TRP 2-Cell 2, 4-15) to the UE through RRC configuration information (4-56). As a method of setting a beam configuration associated with the additional cell with a different PCI from the serving cell (TRP 2-Cell 2, 4-15), i.e., associating a TCI state corresponding to TRP2, a following method of associating and indicating a new cell ID (physical cell ID (PCI), additionalPCI-r17) may be applied.

| | |
|---|---|
| TCI-State ::= | SEQUENCE { |
| tci-StateId | TCI-StateId, |
| gcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PUSCH-PathlossReferenceRS-Id |

OPTIONAL, -- Cond JointTCI

| | |
|---|---|
| ul-powerControl-r17 | Uplink-powerControlId-r17 |

OPTIONAL -- Cond JointTCI
]]
}

In addition, the unified TCI state framework may be applied for inter-cell beam management. The unified TCI state framework applies a common TCI state framework to uplink and downlink and to common and dedicated channels, and may be set to either joint UL/DL mode or separate UL/DL mode.

MIMCParam-r17 ::= SEQUENCE {

| | |
|---|---|
| additionalPCI-ToAddModList-r17 | SEQUENCE (SIZE(1..maxNrofAdditionalPCI-r17)) OF |
| SSB-MTC-AdditionalPCI-r17 OPTIONAL, | -- Need N |
| additionalPCI-ToReleaseList-r17 | SEQUENCE (SIZE(1..maxNrofAdditionalPCI-r17)) OF |
| AdditionalPCIIndex-r17 OPTIONAL, | -- Need N |
| unifiedTCI-StateType-r17 | ENUMERATED (separate, joint) |

OPTIONAL, -- Need R

| | |
|---|---|
| uplink-PowerControlToAddModList-r17 | SEQUENCE (SIZE (1..maxUL-TCI-r17)) OF |
| Uplink-powerControl-r17 OPTIONAL, | -- Need N |
| uplink-PowerControlToReleaseList-r17 | SEQUENCE (SIZE (1..maxUL-TCI-r17)) OF |
| Uplink-powerControlId-r17 OPTIONAL, | -- Need N |
| sfnSchemePDCCH-r17 | ENUMERATED (sfnSchemeA, sfnSchemeB) |

OPTIONAL, -- Need R

| | |
|---|---|
| sfnSchemaPDSCH-r17 | ENUMERATED (sfnSchemeA, sfnSchemeB) |

OPTIONAL -- Need R
}

1. Joint UL/DL mode: set UL and DL to share the same TCI configuration (in PDSCH-Config)

| | |
|---|---|
| dl-OrJoint-TCIStateList-r17 | CHOICE ( |
| explicitlist | SEQUENCE { |
| dl-orJoint-TCI-State-ToAddModList-r17 | SEQUENCE (SIZE (1.. |

maxNrofTCI-States)) OF TCI-State
OPTIONAL, -- Need N

| | |
|---|---|
| dl-orJoint-TCI-State-ToReleaseList-r17 | SEQUENCE (SIZE (1.. |

maxNrofTCI-States)) OF TCI-StateId
OPTIONAL -- Need N
},

| | |
|---|---|
| unifiedTCI-StateRef-r17 | ServingCellAndBWP-Id-r17 |

}

2. Separate UL/DL mode: UL and DL provide their own TCI configurations. The TCI state for DL follows the settings in dl-OrJoint-TCIStateList-r17 (in PDSCH-Config), and the TCI state for UL follows ul-TCI-StateList-r17 (in BWP-UplinkDedicated).

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF |

| | |
|---|---|
| TCI-UL-State-r17 | OPTIONAL, -- Need N |

| | |
|---|---|
| ul-TCI-ToReleaseList-r17 | SEQUENCE (SIZE (1..maxUL-TCI-r17)) OF |

| | |
|---|---|
| TCI-UL-State-Id-r17 | OPTIONAL -- Need N |

},

| | |
|---|---|
| unifiedTCI-StateRef-r17 | ServingCellAndBWP-Id-r17 |

} OPTIONAL, -- Need R

After the UE is provided with the configuration for TRP 2-Cell 2 while in the RRC connected state with serving cell 1, the UE may perform L1 measurement on corresponding TRP 2-Cell 2 according to the configuration and report the result to the serving cell (Cell 1, 4-10) (4-57). Upon determining that a switch from the serving cell beam (TCI state 1, 4-25, 4-30) to a specific beam (TCI state 2, 4-35, 4-40) of TRP 2 (Cell 2, 4-15) is necessary based on the measurement results, the serving cell may trigger beam switching and indicate it to the UE through L1/L2 signaling (4-58). The UE may switch the beam to the specific beam (TCI state 2, 4-40) of TRP 2 (Cell 2, 4-15) based on the indication, and perform physical channel setup and higher layer setup in association with the configured beam. While being connected to the serving cell (Cell 1, 4-10), the UE may perform data transmission and reception (PDCCH/PDSCH reception, PUCCH/PUSCH transmission) by using the channel link of TRP 2 (Cell 2, 4-15). That is, transmission and reception on the common control channel are performed through the serving cell (Cell 1, 4-10).

Thereafter, the UE may perform L3 measurement according to the measurement configuration set in the independent serving cell (4-59). Additionally, the UE may receive a handover command message from the serving base station (Cell 1) and perform a serving cell switch to Cell 2 (4-60). Through this method (4-55), the UE may perform data transmission and reception to and from specific TRP 2 of Cell 2 supporting L1/L2-based mobility in a state of being connected to the serving cell, and may continuously use the corresponding beam even after being handed over.

The RRC configuration for settings and operations related to L1 measurement and reporting at step 4-57 is described below. These contents are basically applied to the following embodiments of the disclosure, and improved techniques may be added in future embodiments.
1. CSI measurement configuration
   CSI-RS resources and resource pools to be measured (nzp-CSI-RS, csi-IM, csi-SSB)
   Configuration of CSI-RS resources to be measured (aperiodic, semi-persistent) and configuration of triggers
   When CSI-RS resources refer to SSB resources, additional PCI information is provided to enable L1 measurement at neighbor cells (up to 7 neighbor cells (PCIs) may be added for one serving cell)

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE |

```
    (SIZE(1..maxNrofCSI-SSB-ResourcePerSet)) OF SSB-Index,
        ...,
        [[
```

| | |
|---|---|
| servingAdditionalPCIList-r17 | SEQUENCE |
| (SIZE(1..maxNrofCSI-SSB-ResourcePerSet)) | OF ServingAdditionalPCIIndex-r17 OPTIONAL -- |

```
    Need R
        ]]
    }
```

| | |
|---|---|
| ServingAdditionalPCIIndex-r17 ::= INT | INTEGER (0..maxNrofAdditionalPCI-r17) |
| SSB-NTC-AdditionalPCI-r17 ::= | SEQUENCE { |
| additionalPCIIndex-r17 | AdditionalPCIIndex-r17, |
| additionalPCI-r17 | PhysCellId, |
| periodicity-r17 | ENUMERATED { ms5, ms10, ms20, ms40, ms80, ms160, |

spare2, spare} },

| | |
|---|---|
| ssb-PositionsInBurst-r17 | CHOICE ( |
| shortBitmap | BIT STRING (SIZE (4)), |
| mediumBitmap | BIT STRING (SIZE (8)), |
| longBitmap | BIT STRING (SIZE (64)) |

},

| | |
|---|---|
| ss-PBCH-BlockPower-r17 | INTEGER (−60..50) |

}

2. CSI reporting configuration
   Reporting type: periodic reporting, semi-periodic reporting over PUCCH, semi-periodic reporting over PUSCH, aperiodic reporting over PUSCH (periodic, semi-persistent for PUCCH, semi-persistent for PUSCH, aperiodic)
   Report quantity
   Other settings required for report

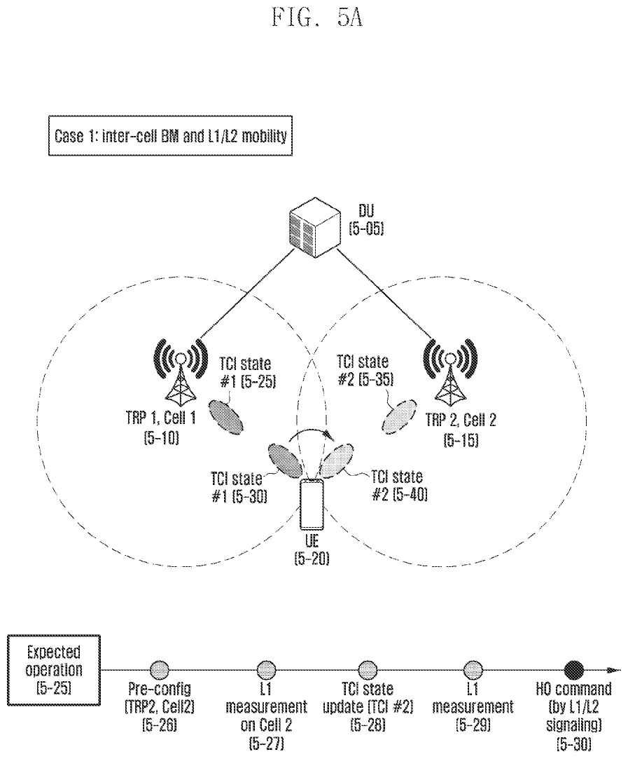

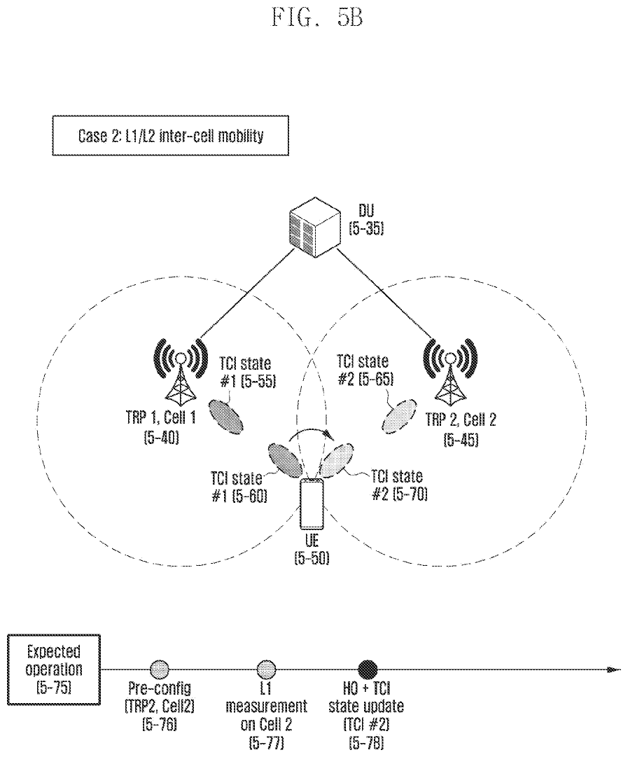

FIGS. 5A and 5B are a diagram illustrating a scenario in which the UE transmits and receives data after performing serving cell and beam change toward a TRP of a cell that supports L1/L2-based beam switching, as embodiments considered in the disclosure. Although these drawings describe a case where multiple cells (TRP1-Cell1, TRP2-Cell2; 5-10, 5-15, 5-40, 5-45) are present within one distributed unit (DU) 5-05 or 5-35, the overall content of this disclosure may also be applied to the inter-DU case (each DU constitutes one TRP-Cell).

The improved beam switch techniques (5-25 and 5-75) considered in these embodiments are as follows.
1. Embodiment 1 (5-25): performing L1/L2 handover after inter-cell beam management (switch) operation
2. Embodiment 2 (5-75): performing L1/L2 handover immediately

First, to describe the overall operation of embodiment 1, the UE may receive, from the serving cell 5-10, common configuration and dedicated configuration information for an additional cell with a different PCI from the serving cell (TRP 2-Cell 2, 5-15) through RRC configuration information (5-26). That is, configuration information corresponding to ServingCellID or candidateCellID (cell ID associated with PCI), ServingCellConfigCommon and ServingCellConfig may be provided to the UE in advance. This configuration information may be provided in the form of pre-configuration through RRC configuration, and the configuration information may include configuration information for multiple cells. In addition, the corresponding configuration information may include all configuration information (cell configuration, bearer configuration, security key configuration, etc.) that is applied when the UE moves to the corresponding cell (handover). In addition, the corresponding configuration information may include the unified TCI state configuration described at step 4-56 and the configuration related to L1 measurement and reporting. The embodiment of this drawing is characterized by providing a structure for providing settings in advance for candidate neighbor cells to which L1/L2 handover may be performed, an operation for selectively applying the settings after handover through L1/L2 signaling, and a specific method for L1/L2 beam switch and cell switch (handover).

After the configuration for TRP 2-Cell 2 (5-15) is provided in an RRC connected state to serving cell 1, at step 5-27, the UE may perform L1 measurement on corresponding TRP 2-Cell 2 (5-15) according to the received configuration and report the result to the serving cell (Cell 1, 5-10). Upon determining that switching from the serving cell beam (TCI state 1, 5-25) to a specific beam (TCI state 2, 5-40) of TRP 2 (Cell 2, 5-15) is necessary based on the measurement results, at step 5-28, the serving cell may trigger beam switching and indicate it to the UE through L1/L2 signaling.

The UE may perform beam switching to TRP 2 (Cell 2, 5-15) through the indication and transmit and receive data through TRP 2 (Cell 2, 5-15). At this time, the serving cell is not changed and the UE is still RRC connected to the serving cell (Cell 1, 5-10). Thereafter, the UE may still perform L1 measurement on TRP 2-Cell 2 (5-15) and report the corresponding result to the serving cell (Cell 1, 5-10). If the L1 measurement reported by the UE satisfies the triggering condition (the detailed operation is described below) for handover toward TRP 2-Cell 2 (5-15), the serving cell (Cell 1, 5-10) may indicate a handover to the UE. This indication may be an L1/L2 message. That is, an indicator indicating a handover may be included in the MAC CE or DCI. The operation for L1/L2 messages will be described in detail in the following embodiments of the disclosure.

To describe the overall operation of embodiment 2, the UE may receive, from the serving cell 5-40, common configuration and dedicated configuration information for an additional cell with a different PCI from the serving cell (TRP 2-Cell 2, 5-45) through RRC configuration information (5-76). That is, the configuration information corresponding to ServingCellID or candidateCellID (cell ID associated with PCI), ServingCellConfigCommon and ServingCellConfig may be provided to the UE in advance. This configuration information may be provided in the form of pre-configuration through RRC configuration, and the configuration information may include configuration information for multiple cells. In addition, the corresponding configuration information may include all configuration information (cell configuration, bearer configuration, security key configuration, etc.) that is applied when the UE moves to the corresponding cell (handover). In addition, the corresponding configuration information may include the unified TCI state configuration described at step 4-56 and the configuration related to L1 measurement and reporting. The embodiment of this drawing is characterized by providing a structure for providing settings in advance for candidate neighbor cells to which L1/L2 handover may be performed, an operation for selectively applying the settings after handover through L1/L2 signaling, and a specific method for L1/L2 beam switch and cell switch (handover).

After the configuration for TRP 2-Cell 2 (5-45) is provided in a RRC connected state to serving cell 1, at step 5-77, the UE may perform L1 measurement on corresponding TRP 2-Cell 2 (5-45) according to the received configuration and report the corresponding result to the serving cell (Cell 1, 5-40). Upon determining that a handover together with beam switching from the serving cell beam (TCI state 1, 5-45) to a specific beam (TCI state 2, 5-70) of TRP 2 (Cell 2, 5-45) is necessary based on the measurement results, at step 5-78, the serving cell may trigger beam switching and handover and indicate it to the UE through L1/L2 signaling.

The UE may perform a handover together with beam switching to TRP 2 (Cell 2, 5-15) according to the corresponding indication and may transmit and receive data through corresponding TRP 2 (Cell 2, 5-15). At this time, the UE may apply the configuration information, having been provided in advance at step 5-76, for the target cell to which handover is executed. Depending on whether uplink synchronization is required at this stage, the UE may perform random access or may omit random access to the target cell. The detailed operations are described in the following drawings.

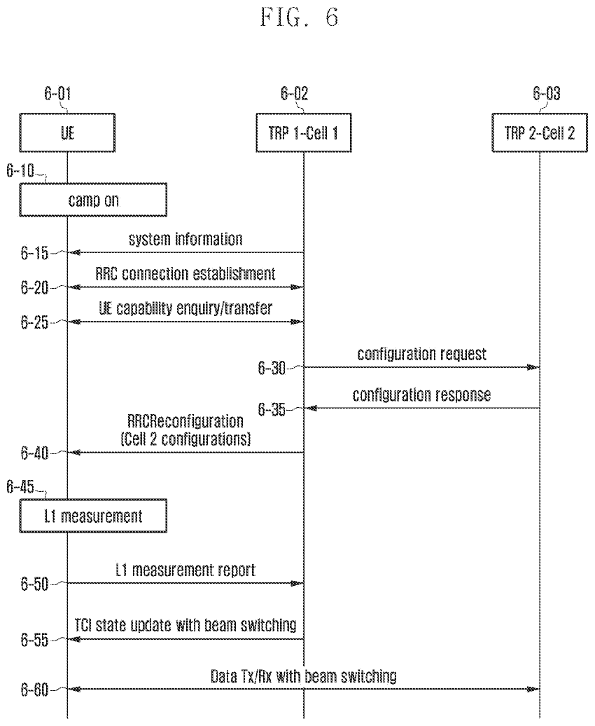

FIG. 6 is a diagram illustrating the overall operation for inter-cell beam management of FIG. 4 referred to in the disclosure.

The UE 6-01 in the camped-on state (6-10) may receive system information (6-15) from cell 1 (6-02) and may perform a transition procedure to the connected state (6-20). Thereafter, the serving cell 6-02 may make a UE capability request (UE capability enquiry message) to the UE and the UE may transmit its UE capability (UE capability information message) to the base station in response to the base station's request (6-25). The UE capability may include whether L1/L2-based inter-cell beam switching/management and handover is supported, and the UE reports its UE capabilities, including at least one of UE-specific capabilities, band-specific capabilities, or band combination-specific capabilities, to the base station.

The serving cell 6-02 may transmit a request for configuration information required for the corresponding UE to perform L1/L2-based beam switching and handover to neighbor cell 2 (6-03) that supports L1/L2-based mobility (6-25), and cell 2 (6-03) may transmit in return a response message including the requested configuration information to the serving cell 6-02 (6-30). The procedure indicated by 6-30 and 6-35 may be omitted in network implementation when cell 1 (6-02) and cell 2 (6-03) are present within one DU (intra-DU scenario).

At step 6-40, the serving cell may transmit the UE common/dedicate configuration information to be applied after L1/L2-based mobility (beam switching) toward cell 2 (6-03) is indicated. For detailed settings and contents, refer to the description in FIG. 4. For the TCI state configuration and L1 measurement and reporting configuration provided at step 6-40, refer to the description in FIG. 4. There may be multiple neighbor cells, and the serving cell may perform the same procedure with multiple neighbor cells. For example, one serving cell may be provided with configurations for up to seven neighbor cells.

Thereafter, the UE may perform L1 measurement in relation to TRP 2-Cell 2 while remaining in the connected state with the serving cell 6-02 at step 6-45, and may report the corresponding measurement result to the serving cell 6-02 according to the L1 measurement reporting configuration set in advance (6-50). The serving cell 6-02 may determine to change the beam of the UE based on the received measurement results, and upon determining that switching from a specific beam of the serving cell (TRP 1-Cell 1) to a specific beam of TRP 2-Cell 2 is necessary, at step 6-55, it may instruct the target cell (TRP 2-Cell 2) to change the TCI state of the UE through L1/L2 signaling. The L1/L2 signaling at step 6-55 may be a MAC CE or DCI, and the L1/L2 signaling may include information indicating switching to a specific beam of TRP 2-Cell 2. For example, a MAC CE may be used when activating multiple TCI states, and one of the activated TCI states may be indicated by a DCI. Alternatively, only one TCI state may be indicated by the MAC CE, in which case the DCI is omitted.

At step 6-60, the UE may perform beam switching to the beam indicated in TRP 2-Cell 2 (6-03) and perform data transmission and reception through the corresponding beam. In this step, the UE may maintain the RRC connection with the serving cell.

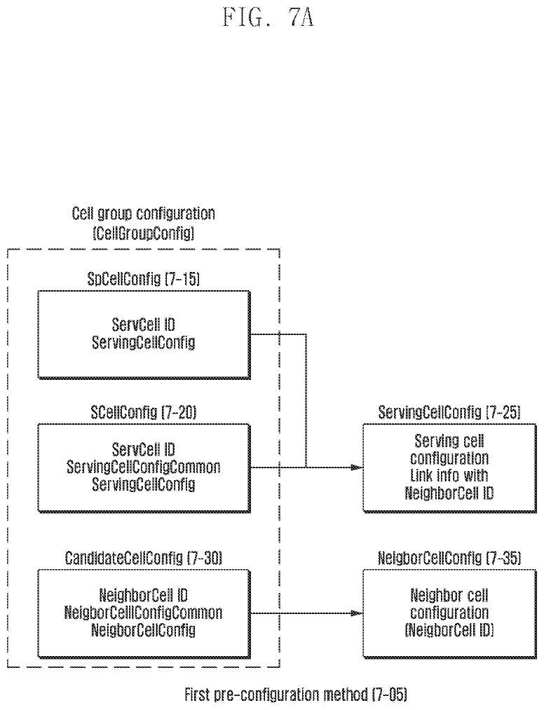

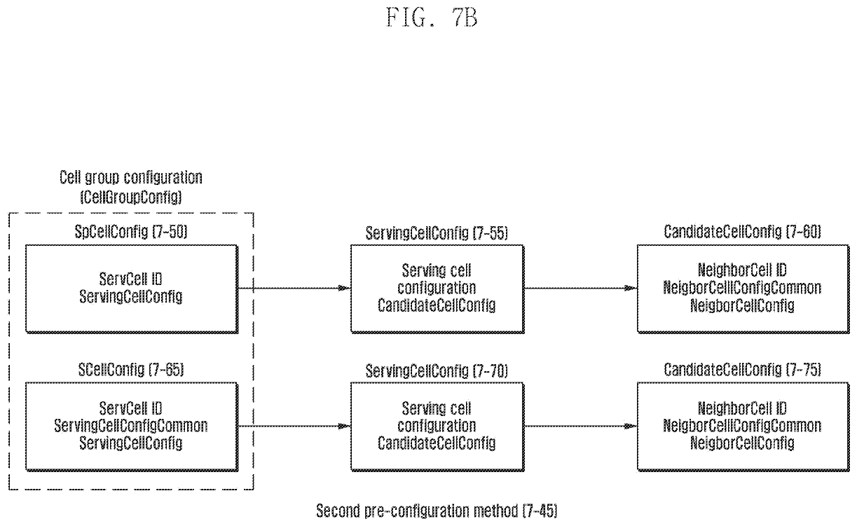

FIGS. 7A and 7B are a diagram illustrating a method for configuring candidate neighbor cells that support L1/L2 inter-cell handover proposed in the disclosure.

These drawings describe, in L1/L2 inter-cell beam switch and handover applied to the embodiments proposed in the disclosure, a structure and method for the serving cell to provide cell configurations to be applied after the UE is handed over to a neighbor cell. The serving cell provides the UE with the configuration information for neighbor cells through pre-configuration, and the UE performs a handover to a neighbor cell associated with the TCI state indicated when the handover and TCI states of neighbor cells are indicated through L1/L2 signaling. Hence, an operation to immediately apply the pre-stored configuration is required. In addition, the number of candidate neighbor cells that support L1/L2 inter-cell beam switch and handover should match the number of neighbor cells that may be associated with beams in the unified TCI state framework. For example, currently, unified TCI state beams set in one serving cell may be associated with up to 7 candidate neighbor cells. For specific details, refer to FIG. 4. Next, a description will be given of pre-configuration methods for neighbor cells proposed in the disclosure.
1. First pre-configuration method (7-05): providing a list of configurations for candidate neighbor cells to be applied after handover at a cell group level.
1) Signaling option 1
   Provides N candidate neighbor cell configurations that are commonly applied within the cell group (CandidateCellConfig, 7-30). For example, N may be the maximum number (7) that is allowed in association with unified TCI states.
   Includes IDs and configuration information of neighbor cells (7-35)
   The same candidate neighbor cell configuration is applied to all serving cells (7-15, 7-20) within the cell group. Alternatively, it is possible to indicate N or fewer neighbor cell configurations to be applied to each serving cell (7-25).
2) Signaling option 2
   Provides M candidate neighbor cell configurations that are commonly applied within the cell group (CandidateCellConfig, 7-30). For example, M may be greater than the maximum number (7) that is allowed in association with unified TCI states (M>7).
   In each serving cell (7-15, 7-20) within the cell group, N of the M candidate neighbor cell configurations set in the cell group may be selected and applied (7-25). For example, N may be less than or equal to the maximum number (7) that is allowed in association with unified TCI states (N<=7).
2. Second pre-configuration method (7-45): providing a list of configurations for candidate neighbor cells to be applied after handover at a serving cell level.
   Provide up to N candidate neighbor cell configurations from each serving cell (7-50, 7-65) (CandidateCellConfig, 7-60, 7-75). For example, N may be the maximum number (7) that is allowed in association with unified TCI states.
   Providing the configurations of the neighbor cells associated with the serving cell at the serving cell level (7-55, 7-70) is consistent with the operation of indicating the TCI states for each serving cell in the unified TCI state framework and configuring N neighbor cells associated with the corresponding beam. For example, N may be the maximum number (7) that is allowed in association with unified TCI states.
   Includes IDs and configuration information of neighbor cells (7-60, 7-75)
   This method provides a high degree of freedom for each serving cell, but the number of configurations for neighbor cells increases, which may result in a high signaling load.

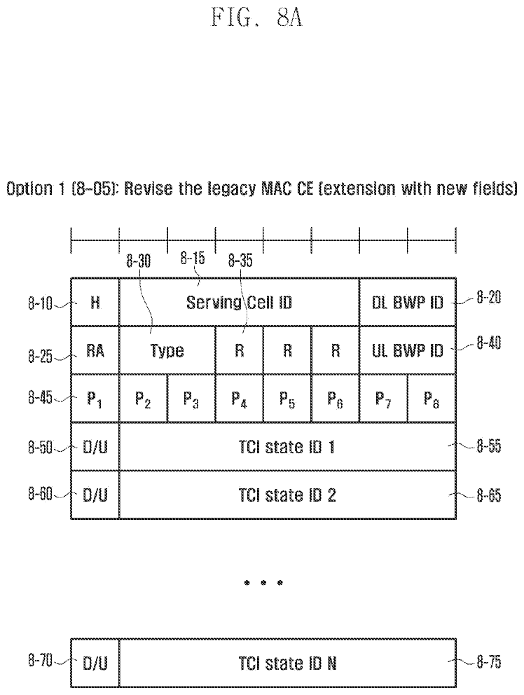

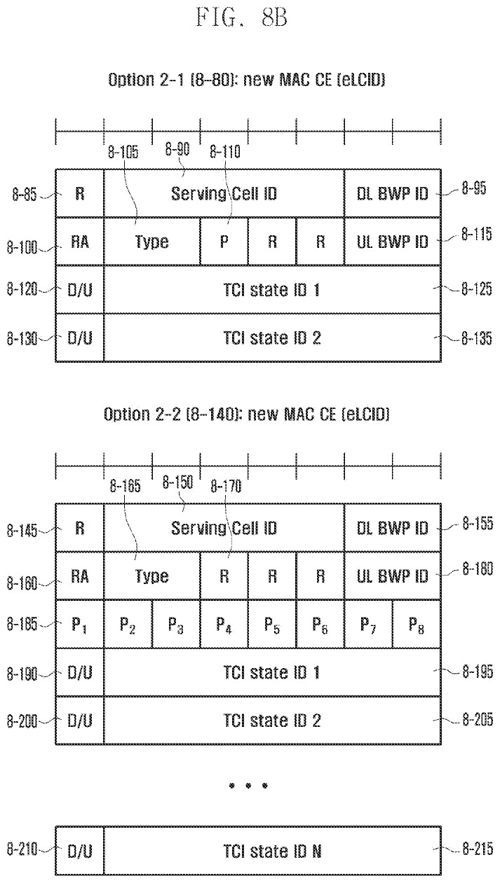

FIGS. 8B and 8B indicate a MAC CE and DCI format for L1/L2-based beam switching and handover proposed in the disclosure. The method proposed in these drawings is a MAC CE format and DCI for L1/L2 inter-cell beam switching and handover that is applied to the entire embodiments proposed in the disclosure. That is, the corresponding L1/L2 signaling is used as a dynamic switching method that instructs a handover together with beam switching to a candidate neighbor cell. The following two methods may be considered.
1. First L1/L2 signaling method: legacy L1/L2 inter-cell beam switch MAC CE and DCI process
1) Activate multiple TCI states by use of a MAC CE, and indicate a TCI state for one neighbor cell by use of a DCI.
2) Activate (indicate) TCI states for one neighbor cell by use of a MAC CE.
2. Second L1/L2 signaling method: activate (indicate) TCI states for one neighbor cell by use of a new MAC CE

The MAC CE format that may be applied to the two signaling methods above is as follows.
1. MAC CE signaling option 1 for L1/L2 inter-cell beam switch and handover (8-05)
   Reuse the legacy L1/L2 inter-cell beam switch MAC CE without modifications or with modifications. Applicable to the above first L1/L2 signaling method.
   That is, the DCI following the corresponding MAC CE indicates a handover and one TCI state.
   Use some of the reserved bits as a new modified field
a) ‘H’ field (8-10): indicator indicating whether to perform handover
b) Serving Cell ID (8-15)
c) DL BWP ID (8-20)
d) RA field (8-25): indicator indicating whether random access to the target cell is required when performing a handover. This field may be set to ‘1’ only when the H field is set to ‘1’ to indicate handover. If the RA field is set to ‘1’, random access may be indicated.
e) Type field (8-30): field that includes information on whether to perform CBRA or CFRA and whether to perform 2-step RACH or 4-step RACH when receiving a random access indication after performing a handover. For example, “00” may indicate performing CBRA and 2-step RACH toward the target cell; “01” may indicate performing CBRA and 4-step RACH; “10” may indicate performing CFRA and 2-step RACH; “11” may indicate performing CFRA and 4-step RACH. However, this is only an example of how the Type field is set, and the relationship between the Type field and the information indicated by the Type field may be changed.
f) ‘R’ field (8-35): reserved field
g) UL BWP ID (8-40)
h) Pᵢ field (8-45): field indicating whether the i^{th} TCI state field below indicates beams in two TRPs. If the Pᵢ field is set to ‘1’, the corresponding i^{th} TCI state codepoint is composed of two TCI states; if it is set to ‘0’, the corresponding i^{th} TCI state codepoint is composed of one TCI state.
i) D/U field (8-50, 8-60, 8-70): Indicator indicating whether the TCI state ID is set in UL or DL.
j) TCI state ID field (8-55, 8-65, 8-75): field indicating the TCI state. The corresponding beam is set as a unified TCI state and is associated with a specific neighbor cell. The associated PCI settings are provided by the RRC configuration.
2. MAC CE signaling option 2-1 (8-80) for L1/L2 inter-cell beam switch and handover
   Uses newly introduced MAC CE
   The H field may be present, but it may be omitted since handover is already indicated by LCID/eLCID.
   Handover may be directly indicated without DCI by indicating only one TCI state. Applicable to the above second L1/L2 signaling method.
a) ‘R’ field (8-85): reserved field
b) Serving Cell ID (8-90)
c) DL BWP ID (8-95)
d) RA field (8-100): indicator indicating whether random access toward the target cell is required when performing a handover. If the RA field is set to ‘1’, random access may be indicated.
e) Type field (8-105): field that includes information on whether to perform CBRA or CFRA and whether to perform 2-step RACH or 4-step RACH when receiving a random access indication after performing a handover. For example, “00” may indicate performing CBRA and 2-step RACH toward the target cell; “01” may indicate performing CBRA and 4-step RACH; “10” may indicate performing CFRA and 2-step RACH; “11” may indicate performing CFRA and 4-step RACH. However, this is only an example of how the Type field is set, and the relationship between the Type field and the information indicated by the Type field may be changed.
f) P field (8-105): field indicating whether the TCI state field below indicates beams in two TRPs. If the P field is set to ‘1’, the corresponding TCI state codepoint is composed of two TCI states; if it is set to ‘0’, the corresponding i^{th} TCI state codepoint is composed of one TCI state.
g) UL BWP ID (8-110)
h) D/U field (8-190, 8-200, 8-210): Indicator indicating whether the TCI state ID is set in UL or DL.
i) TCI state ID field (8-195, 8-205, 8-215): field indicating the TCI state. The corresponding beam is set as a unified TCI state and is associated with a specific neighbor cell. The associated PCI settings are provided by the RRC configuration.
3. MAC CE signaling option 2-2 (8-140) for L1/L2 inter-cell beam switch and handover
   Uses newly introduced MAC CE. Applicable to the above first L1/L2 signaling method.
   That is, the DCI following the corresponding MAC CE indicates a handover and one TCI state.
   The H field may be present, but it may be omitted since handover is already indicated by LCID/eLCID.
a) ‘R’ field (8-145): reserved field
b) Serving Cell ID (8-150)
c) DL BWP ID (8-155)
d) RA field (8-160): indicator indicating whether random access toward the target cell is required when performing a handover. If the RA field is set to ‘1’, random access may be indicated.
e) Type field (8-165): field that includes information on whether to perform CBRA or CFRA and whether to perform 2-step RACH or 4-step RACH when receiving a random access indication after performing a handover. For example, “00” may indicate performing CBRA and 2-step RACH toward the target cell; “01” may indicate performing CBRA and 4-step RACH; “10” may indicate performing CFRA and 2-step RACH; “11” may indicate performing CFRA and 4-step RACH. However, this is only an example of how the Type field is set, and the relationship between the Type field and the information indicated by the Type field may be changed.
f) UL BWP ID (8-180)
g) Pᵢ field (8-185): field indicating whether the i^{th} TCI state field below indicates beams in two TRPs. If the Pᵢ field is set to ‘1’, the corresponding i^{th} TCI state codepoint is composed of two TCI states; if it is set to ‘0’, the corresponding i^{th} TCI state codepoint is composed of one TCI state.
h) D/U field (8-190, 8-200, 8-210): Indicator indicating whether the TCI state ID is set in UL or DL.
i) TCI state ID field (8-195, 8-205, 8-215): field indicating the TCI state. The corresponding beam is set as a unified TCI state and is associated with a specific neighbor cell. The associated PCI settings are provided by the RRC configuration.

In the above description, the situation where a handover can be indicated directly without random access may correspond to a case where the uplink timing advance between the serving cell and the target cell to which the handover is performed matches in an intra-DU situation, and may be a case where these cells are aware that the uplink synchronization is aligned through inter-cell information and exchange. The same applies to ideal backhaul.

Among the operations described above in the MAC CE, the following may also be provided by the DCI as in the MAC CE.
1) An indicator indicating whether to perform a handover.
2) An indicator indicating whether to perform random access during handover
   An indicator indicating CBRA or CFRA
   An indicator indicating 2-step RACH or 4-step RACH

Additionally, in order for the UE to perform L1/L2 inter-cell beam switching and handover, a procedure is required to notify the base station that the above L1/L2 signaling transmitted by the base station has been successfully received and that inter-cell beam switching and handover will be performed according to the corresponding operation. That is, it is necessary for the base station to identify when L1/L2 inter-cell beam switching and handover has been performed and when the corresponding procedure has been completed. The disclosure proposes the following two methods.
1. First method for identifying completion of L1/L2 inter-cell beam switch and handover
   When the UE completes random access to the target cell, it is determined that L1/L2 inter-cell beam switch and handover operation is completed.
   Releasing configurations for the previous serving cell and completing forwarding of data to the target cell.
2. Second method for identifying completion of L1/L2 inter-cell beam switch and handover
   When the UE is indicated to perform handover through L1/L2 signaling, it transmits a confirmation MAC CE to the source serving cell.
   Introducing new confirmation MAC CE and procedure (identified via LCID/eLCID and additional information may be included)
a) Step 1: the UE is indicated to perform handover through L1/L2 signaling.
b) Step 2: the UE applies configurations to the target cell (applies configurations provided through pre-configuration)
c) Step 3: the UE transmits confirmation MAC CE
d) Step 4: (optionally) perform random access to the target cell

Note: the order of steps 3 and 4 is determined depending upon UE implementation.
Release configurations for the serving cell and complete data forwarding to the target cell

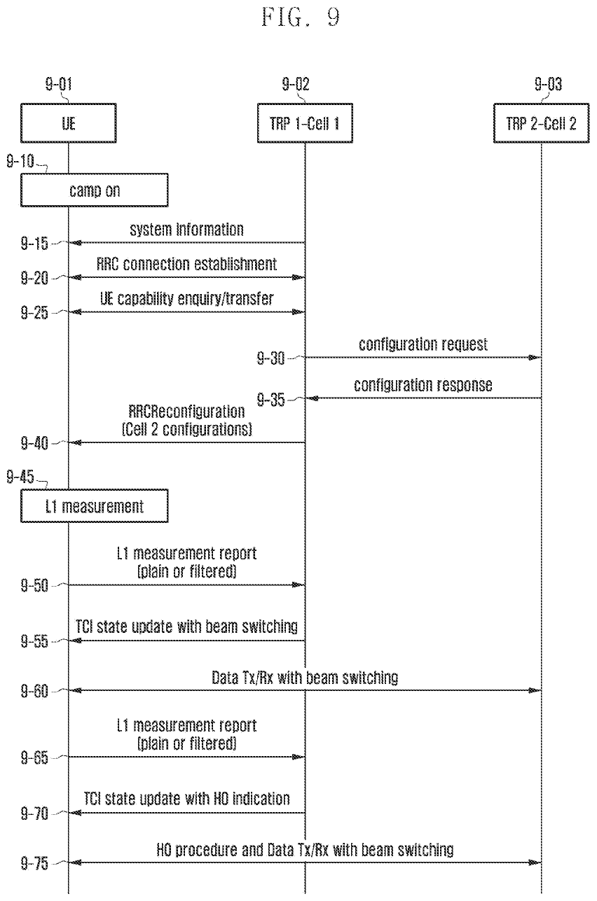

FIG. 9 is a diagram illustrating the overall operation of performing handover after applying L1/L2 inter-cell beam management as Embodiment 1 applied to the disclosure.

The UE 9-01 in the camped-on state (9-10) may receive system information (9-15) from cell 1 (9-02) and may perform a transition procedure to the connected state (9-20). Thereafter, the serving cell 9-02 may make a UE capability request (UE capability enquiry message) to the UE and the UE may transmit its UE capability (UE capability information message) to the base station in response to the base station's request (9-25). The UE capability may include whether L1/L2-based inter-cell beam switching/management and handover is supported, and the UE reports its UE capabilities, including at least one of UE-specific capabilities, band-specific capabilities, or band combination-specific capabilities, to the base station.

The serving cell 9-02 may transmit a request for configuration information required for the corresponding UE to perform L1/L2-based beam switching and handover to neighbor cell 2 (9-03) that supports L1/L2-based mobility (9-25), and cell 2 (9-03) may transmit in return a response message including the requested configuration information to the serving cell 9-02 (9-30). The procedure indicated by 9-30 and 9-35 may be performed through inter-node RRC messages or Xn, F1 interfaces, or the like, and may be performed to exchange configurations related to the pre-configuration of cells involved in L1/L2 inter-cell beam switching and handover. It may be omitted in network implementation when cell 1 (9-02) and cell 2 (9-03) are present within one DU (intra-DU scenario).

At step 9-40, the serving cell may transmit the UE common/dedicate configuration information to be applied after L1/L2-based mobility (beam switching and handover) toward cell 2 (9-03) is indicated. In this embodiment, the difference from FIG. 6 is that common and dedicated configuration information for an additional cell (TRP 2-Cell 2, 9-03) with a different PCI from the serving cell are included at step 9-40. That is, the configuration information corresponding to ServingCellID or candidateCellID (cell ID associated with PCI), ServingCellConfigCommon and ServingCellConfig may be provided to the UE in advance. The corresponding configuration information may be provided in the form of pre-configuration through RRC configuration, and the above configuration information may include configuration information for multiple cells. In addition, the corresponding configuration information may include all configuration information (cell configuration, bearer configuration, security key configuration, or the like) to be applied when the UE moves to the corresponding cell (handover). Further, the corresponding configuration information may include the unified TCI state configuration described at step 4-56 and the configuration related to L1 measurement and reporting. This embodiment proposes an RRC structure for supporting L1/L2 inter-cell beam switch (management) and handover operations, especially a pre-configuration method for candidate neighbor cells, and proposes an L1/L2 signaling method for the base station to indicate inter-cell beam switch and handover based on L1 measurement values. When inter-cell beam switch and handover is indicated by L1/L2-based signaling, the configurations preset for the cell to which handover is indicated are applied. That is, at step 9-40, the RRC structure for supporting L1/L2 inter-cell beam switch (management) and handover operation, especially pre-configuration for candidate neighbor cells, is provided, in which case the contents described in FIGS. 7A and 7B are applied.

Thereafter, the UE may perform L1 measurement in relation to TRP 2-Cell 2 while remaining in the connected state with the serving cell 9-02 at step 9-45, and may report the corresponding measurement result to the serving cell 9-02 according to the L1 measurement reporting configuration set in advance (9-50). For L1 measurement value reporting, one of the methods described above (L1 measurement improvement methods) may be applied.

The serving cell 9-02 may determine to change the beam of the UE based on the received measurement results, and upon determining that switching from a specific beam of the serving cell (TRP 1-Cell 1) to a specific beam of TRP 2-Cell 2 is necessary, at step 9-55, it may instruct the target cell (TRP 2-Cell 2) to change the TCI state of the UE through L1/L2 signaling. The L1/L2 signaling at step 9-55 may be a MAC CE or DCI, and the L1/L2 signaling may include information indicating switching to a specific beam of TRP 2-Cell 2. For example, a MAC CE may be used when activating multiple TCI states, and one of the activated TCI states may be indicated by a DCI. Alternatively, only one TCI state may be indicated by the MAC CE, in which case the DCI is omitted.

At step 9-60, the UE may perform beam switching to the beam indicated in TRP 2-Cell 2 (9-03) and perform data transmission and reception through the corresponding beam. In this step, the UE may maintain the RRC connection with the serving cell. The above L1/L2 signaling may be one of the methods described in FIGS. 8A and 8B.

Thereafter, the UE may perform L1 measurement in relation to TRP 2-Cell 2 while remaining in the connected state with the serving cell 9-02, and may report the corresponding measurement result to the serving cell 9-02 according to the L1 measurement reporting configuration set in advance (9-65). The serving cell 9-02 may determine to perform cell switching (handover) of the UE based on the received measurement results, and may instruct the UE to execute a handover together with changing the TCI state to the target cell (TRP 2-Cell 2) through L1/L2 signaling at step 9-70. The L1/L2 signaling at step 9-70 may be a MAC CE or DCI, and the L1/L2 signaling may include information indicating switching to a specific beam of TRP 2-Cell 2 and handover (indicated through a field in LCID or MAC CE). For example, a MAC CE may be used when activating multiple TCI states, and one of the activated TCI states may be indicated by a DCI. Alternatively, only one TCI state may be indicated by the MAC CE, in which case the DCI is omitted. The L1/L2 signaling may be one of the methods described in FIGS. 8A and 8B. At step 9-75, the UE may perform a handover to TRP 2-Cell 2 (9-03), switch the beam to the indicated beam, and perform data transmission and reception through the corresponding beam.

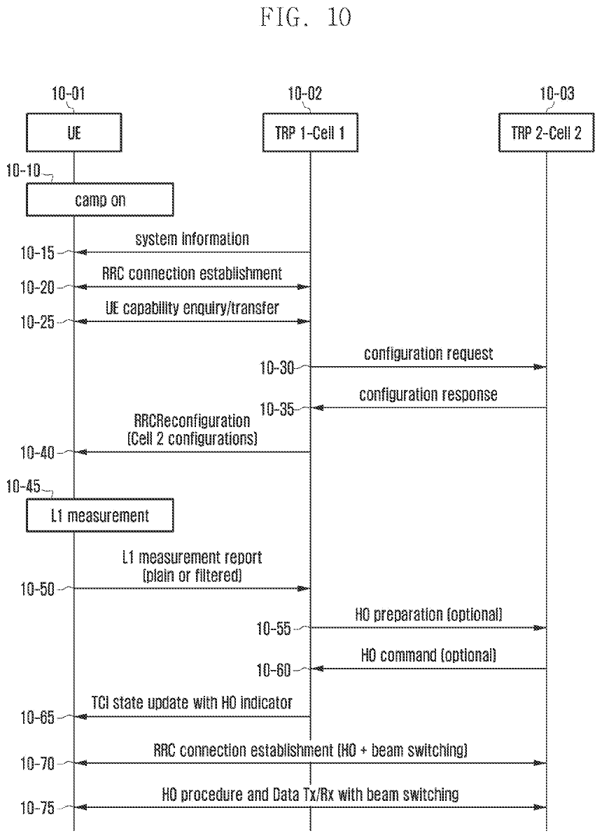

FIG. 10 is a diagram illustrating the overall operation of performing L1/L2 inter-cell handover as Embodiment 2 applied to the disclosure.

The UE 10-01 in the camped-on state (10-10) may receive system information (10-15) from cell 1 (10-02) and may perform a transition procedure to the connected state (10-20). Thereafter, the serving cell 10-02 may make a UE capability request (UE capability enquiry message) to the UE and the UE may transmit its UE capability (UE capability information message) to the base station in response to the base station's request (10-25). The UE capability may include whether L1/L2-based inter-cell beam switching/management and handover is supported, and the UE reports its UE capabilities, including at least one of UE-specific capabilities, band-specific capabilities, or band combination-specific capabilities, to the base station.

The serving cell 10-02 may transmit a request for configuration information required for the corresponding UE to perform L1/L2-based beam switching and handover to neighbor cell 2 (10-03) that supports L1/L2-based mobility (10-25), and cell 2 (10-03) may transmit in return a response message including the requested configuration information to serving cell 1 (10-02) (10-30). The procedure indicated by 9j30 and 10-35 may be performed through inter-node RRC messages or Xn, F1 interfaces, or the like, and may be performed to exchange configurations related to the pre-configuration of cells involved in L1/L2 inter-cell beam switching and handover. It may be omitted in network implementation when cell 1 (10-02) and cell 2 (10-03) are present within one DU (intra-DU scenario).

At step 10-40, the serving cell may transmit the UE common/dedicate configuration information to be applied after L1/L2-based mobility (beam switching and handover) toward cell 2 (10-03) is indicated. In this embodiment, the difference from FIG. 6 is that common and dedicated configuration information for an additional cell (TRP 2-Cell 2, 10-03) with a different PCI from the serving cell are included at step 10-40. That is, the configuration information corresponding to ServingCellID or candidateCellID (cell ID associated with PCI), ServingCellConfigCommon and ServingCellConfig may be provided to the UE in advance. The corresponding configuration information may be provided in the form of pre-configuration through RRC configuration, and the above configuration information may include configuration information for multiple cells. In addition, the corresponding configuration information may include all configuration information (cell configuration, bearer configuration, security key configuration, or the like) to be applied when the UE moves to the corresponding cell (handover). Further, the corresponding configuration information may include the unified TCI state configuration described at step 4-56 and the configuration related to L1 measurement and reporting. This embodiment proposes an RRC structure for supporting L1/L2 inter-cell beam switch (management) and handover operations, especially a pre-configuration method for candidate neighbor cells, and proposes an L1/L2 signaling method for the base station to indicate inter-cell beam switch and handover based on L1 measurement values. When inter-cell beam switch and handover is indicated by L1/L2-based signaling, the configurations preset for the cell to which handover is indicated are applied. That is, at step 10-40, the RRC structure for supporting L1/L2 inter-cell beam switch (management) and handover operation, especially pre-configuration for candidate neighbor cells, is provided, in which case the contents described in FIGS. 7A and 7B are applied.

Thereafter, the UE may perform L1 measurement in relation to TRP 2-Cell 2 while remaining in the connected state with the serving cell 10-02 at step 10-45, and may report the corresponding measurement result to the serving cell 10-02 according to the L1 measurement reporting configuration set in advance (10-50). For L1 measurement value reporting, one of the methods described above (L1 measurement improvement methods) may be applied.

The serving cell 10-02 may determine to change the cell (handover) of the UE based on the received measurement results, and may perform a handover negotiation procedure with the target cell through making a handover request (10-55) and receiving a configuration message (10-60). Then, at step 10-65, the serving cell 10-02 instructs the UE to perform a handover together with changing the TCI state of the UE to the target cell (TRP 2-Cell 2) through L1/L2 signaling. The above L1/L2 signaling may be one of the methods described in FIGS. 8A and 8B. Note that steps 10-50 and 10-55 may be omitted either in the intra-DU case in terms of network implementation or in the case where relevant information has already been shared at step 10-40. The L1/L2 signaling at step 10-65 may be a MAC CE or DCI, and the L1/L2 signaling may include information indicating switching to a specific beam of TRP 2-Cell 2 and handover. For example, a MAC CE may be used when activating multiple TCI states, and one of the activated TCI states may be indicated by a DCI. Alternatively, only one TCI state may be indicated by the MAC CE, in which case the DCI is omitted.

The UE may perform a handover to TRP 2-Cell 2 (10-03) and switch the beam to the indicated beam at step 10-70, and may perform data transmission and reception through the corresponding beam at step 7-75.

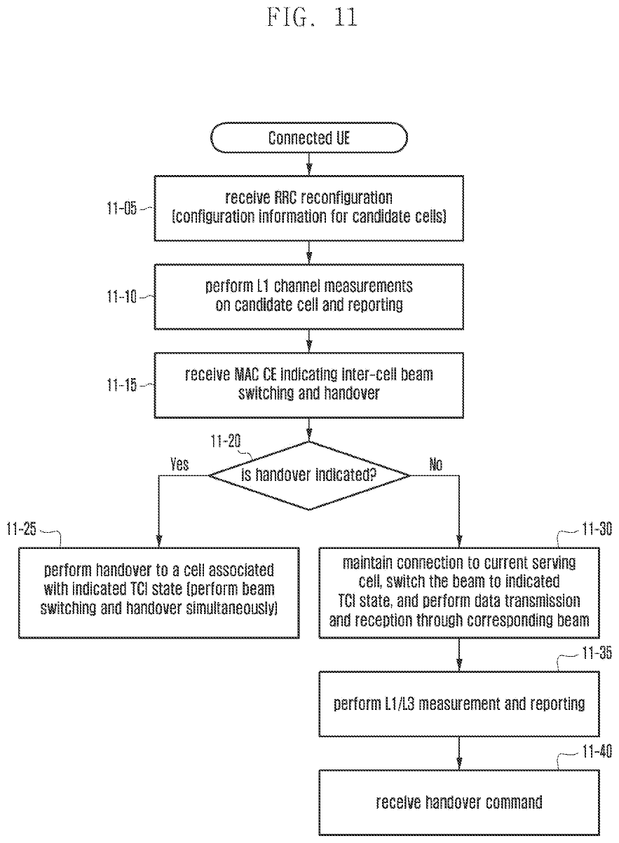

FIG. 11 is a diagram illustrating UE operations that indicate L1/L2 inter-cell beam switch and handover with MAC CE only in the overall UE operation for performing L1/L2-based beam switch and handover, applied to embodiments of the disclosure.

At step 11-05, the UE in the connected state may receive, from the serving cell through an RRC reconfiguration message, common/dedicate configuration information of neighbor cells to be applied after L1/L2-based mobility is indicated. For detailed configuration methods and contents, refer to the descriptions related to FIGS. 4, 5A, 5B, 7A, and 7B. Thereafter, at step 11-10, the UE may perform L1 measurements in relation to a candidate neighbor cell while remaining in the connected state with the serving cell, and may report the measurement results to the serving cell according to the preset L1 measurement reporting configuration.

The serving cell may determine whether to instruct the UE to perform beam switch and handover based on the received measurement results, and upon determining that a beam switch from a specific beam of the serving cell to a specific beam of a neighbor cell is necessary, at step 11-15, it may instruct the UE to change the TCI state through L1/L2 signaling. The above L1/L2 signaling is different from the legacy operation in that it may also trigger a handover. In this drawing, the above L1/L2 signaling is a MAC CE, and the MAC CE may include information indicating both specific beams of neighbor cells and serving cell change. At step 11-20, the UE may check whether there is a handover indication in the MAC CE signaling received at step 11-15, and then operate differently. For the specific format and related operations of the MAC CE, refer to FIGS. 8A and 8B.

If a handover is indicated in the MAC CE received at step 11-20 (new MAC CE directly indicates a handover, or a specific field of MAC CE indicates whether to perform handover), at step 11-25, the UE may perform a handover to a cell associated with the indicated TCI state, apply the configuration for the corresponding cell that has been stored as pre-configuration according to handover execution, and perform data transmission and reception by using the indicated beam.

If the MAC CE received at step 11-20 does not indicate a handover (legacy inter-cell beam switch MAC CE is received, or a specific field in new MAC CE does not indicate whether to perform a handover), at step 11-30, the UE may maintain the connection to the current serving cell, switch the beam to the TCI state of the indicated cell, and perform data transmission and reception through the corresponding beam. After beam switching, data transmission and reception are performed through the dedicated channels (PDCCH/PDSCH and PUCCH/PUSCH) of the corresponding beam.

At step 11-35, the UE may perform L1 measurement and reporting and RRM (radio resource management) procedures for neighbor cells, i.e., L3 measurement and channel reporting operations. In this step, if the serving cell determines that a handover to a neighbor cell is necessary through the L1 measurement report or L3 measurement report from the UE, the serving cell may instruct the UE to change the serving cell by issuing a handover command. At step 11-40, the UE may receive a handover command through L1/L2 signaling or an RRC message, and if the UE having received it is already performing beam switching to a neighbor cell and performing data transmission and reception with the corresponding cell, random access related operations may be omitted. The UE may change the serving cell according to the handover command and release the configurations of the previous serving cell.

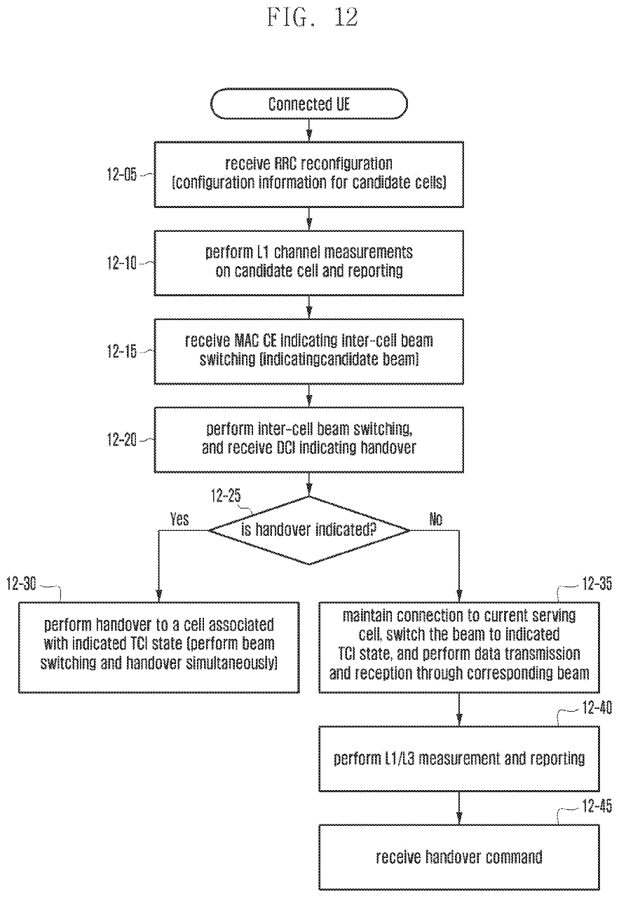

FIG. 12 is a diagram illustrating UE operations for indicating L1/L2 inter-cell beam switch and handover with MAC CE and DCI in the overall UE operation for performing L1/L2-based beam switch and handover, applied to embodiments of the disclosure.

At step 12-05, the UE in the connected state may receive, from the serving cell through an RRC reconfiguration message, common/dedicate configuration information of neighbor cells to be applied after L1/L2-based mobility is indicated. For detailed configuration methods and contents, refer to the descriptions related to FIGS. 4, 5A, 5B, 7A, and 7B. Thereafter, at step 12-10, the UE may perform L1 measurements in relation to a candidate neighbor cell while remaining in the connected state with the serving cell, and may report the measurement results to the serving cell according to the preset L1 measurement reporting configuration.

The serving cell may determine whether to instruct the UE to perform beam switch and handover based on the received measurement results, and upon determining that a beam switch from a specific beam of the serving cell to a specific beam of a neighbor cell is necessary, at step 12-15, it may instruct the UE to change the TCI state through L1/L2 signaling. The above L1/L2 signaling is different from the legacy operation in that it may also trigger a handover. In this drawing, the above L1/L2 signaling is a MAC CE and DCI. Here, the MAC CE may include information indicating both a specific beam of a neighbor cell and serving cell change (MAC CE indicates only one beam). Alternatively, the MAC CE may indicate specific multiple beams of a neighbor cell, and the subsequent DCI transmitted at step 12-20 may select one of the multiple beams of the neighbor cell activated by the MAC CE. Thereby, a handover may be indicated.

At step 12-25, the UE may check whether there is a handover indication in the MAC CE and DCI signaling received at steps 12-15 and 12-20, and then operate differently. For the specific format and related operations of the MAC CE, refer to FIGS. 8A and 8B.

If a handover is indicated in the MAC CE and DCI received at step 12-25 (MAC CE itself indicates a handover, or MAC CE activates multiple beams and DCI indicates one of these beams to thereby indicate a handover), at step 12-30, the UE may perform a handover to a cell associated with the indicated TCI state, apply the configuration for the corresponding cell that has been stored as pre-configuration according to handover execution, and perform data transmission and reception by using the indicated beam.

If no handover is indicated in the MAC CE and DCI received at step 12-25 (MAC CE does not indicate a handover, or DCI does not indicate a handover), at step 12-35, the UE may maintain the connection to the current serving cell, switch the beam to the TCI state of the indicated cell, and perform data transmission and reception through the corresponding beam. After beam switching, data transmission and reception are performed through the dedicated channels (PDCCH/PDSCH and PUCCH/PUSCH) of the corresponding beam. At step 12-40, the UE may perform L1 measurement and reporting and RRM (radio resource management) procedures for neighbor cells, i.e., L3 measurement and channel reporting operations. In this step, if the serving cell determines that a handover to a neighbor cell is necessary through the L1 measurement report or L3 measurement report from the UE, the serving cell may instruct the UE to change the serving cell by issuing a handover command. At step 12-45, the UE may receive a handover command through L1/L2 signaling or an RRC message, and if the UE having received it is already performing beam switching to a neighbor cell and performing data transmission and reception with the corresponding cell, random access related operations may be omitted. The UE may change the serving cell according to the handover command and release the configurations of the previous serving cell.

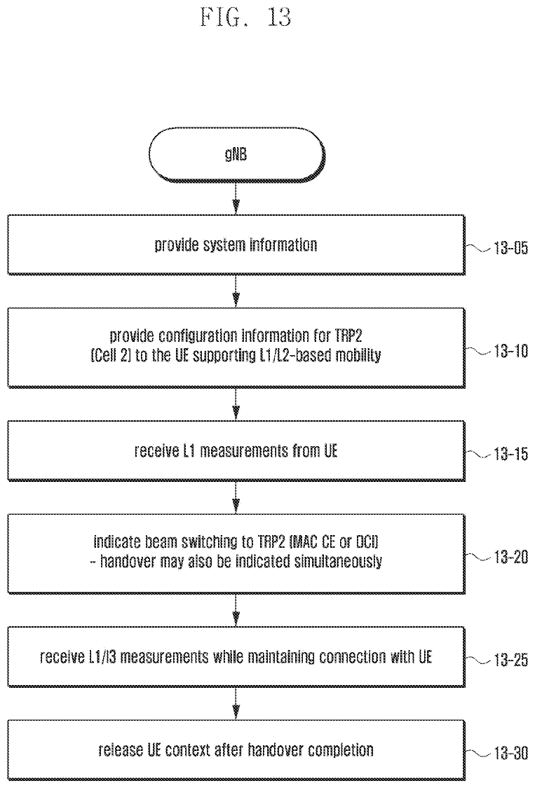

FIG. 13 is a diagram illustrating base station operations applied to embodiments of the disclosure.

At step 13-05, the base station may provide system information to the UE. At step 13-10, the serving cell may transmit, to the UE in the connected state through an RRC reconfiguration message, common/dedicate configuration information of neighbor cells that is to be applied after L1/L2-based mobility is indicated. For detailed configuration methods and contents, refer to descriptions related to FIGS. 4, 5A, and 5B.

Thereafter, at step 13-15, the base station may receive L1 measurement values from the UE, where the measurement values may be measurements on neighbor cells (non-serving cell) supporting L1/L2-based mobility. The serving cell may determine whether to change the beam of the UE based on the received measurement results, and upon determining that a beam switch from a specific beam of the serving cell to a specific beam of a neighbor cell is necessary, at step 13-20, it may command the UE to change the TCI state through L1/L2 signaling. The above L1/L2 signaling may be a MAC CE or DCI, and the above L1/L2 signaling may include information indicating switching to a specific beam of a neighbor cell. In addition, a handover may also be indicated through L1/L2 signaling at this step. If a handover is also indicated, the serving cell may execute the handover procedure, and may delete the UE context and release the connection when the handover to the target cell is completed. The above description is characterized in that the measurement value used to determine whether to perform a handover is L1 measurement. For the various proposed methods, refer to FIGS. 9 and 10.

If the above L1/L2 signaling does not include a handover procedure, the serving cell may remain in the connected state with the UE at step 13-25. At this step, the UE may perform data transmission and reception through dedicated channels (PDCCH/PDSCH and PUCCH/PUSCH) by applying the preset configuration information for the neighbor cells. The UE may also return to the current serving cell from the link with a neighbor cell.

At step 13-25, the base station may receive additional L1/L3 measurement reports while remaining in the connected state with the UE. If the serving cell determines that a handover to a neighbor cell is necessary, it may instruct the UE to change the serving cell by transmitting a handover message. At step 13-30, after the UE changes the serving cell according to the handover indication, it may release the configurations of the previous serving cell.

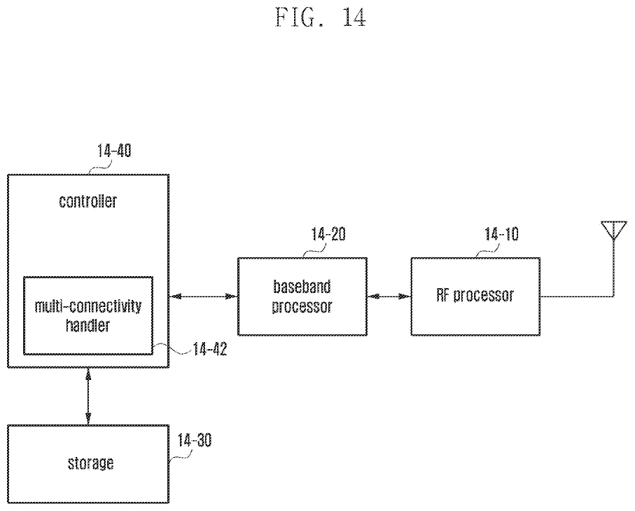

FIG. 14 is a block diagram showing the internal structure of a UE to which the disclosure is applied.

With reference to the drawing, the UE may include a radio frequency (RF) processor 14-10, a baseband processor 14-20, a storage 14-30, and a controller 14-40.

The RF processor 14-10 performs a function for transmitting and receiving a signal through a radio channel, such as signal band conversion and amplification. That is, the RF processor 14-10 performs up-conversion of a baseband signal provided from the baseband processor 14-20 into an RF-band signal and transmit it through an antenna, and performs down-conversion of an RF-band signal received through an antenna into a baseband signal. For example, the RF processor 14-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Also, the RF processor 14-10 may include a plurality of RF chains. Further, the RF processor 14-10 may perform beamforming. For beamforming, the RF processor 14-10 may adjust phases and magnitudes of individual signals transmitted and received through the plural antennas or antenna elements. Further, the RF processor may perform MIMO (multi input multi output), and may receive several layers during an MIMO operation.

The baseband processor 14-20 performs conversion between a baseband signal and a bit stream in accordance with the physical layer specification of the system. For example, during data transmission, the baseband processor 14-20 generates complex symbols by encoding and modulating a transmission bit stream. Further, during data reception, the baseband processor 14-20 restores a reception bit stream by demodulating and decoding a baseband signal provided from the RF processor 14-10. For example, in the case of utilizing orthogonal frequency division multiplexing (OFDM), for data transmission, the baseband processor 14-20 generates complex symbols by encoding and modulating a transmission bit stream, maps the complex symbols to subcarriers, and composes OFDM symbols through inverse fast Fourier transform (IFFT) operation and cyclic prefix (CP) insertion. Further, for data reception, the baseband processor 14-20 divides a baseband signal provided from the RF processor 14-10 in units of OFDM symbols, restores the signals mapped to subcarriers through fast Fourier transform (FFT) operation, and restores the reception bit stream through demodulation and decoding.

The baseband processor 14-20 and the RF processor 14-10 transmit and receive signals as described above. The baseband processor 14-20 and the RF processor 14-10 may be called a transmitter, a receiver, a transceiver, or a communication unit. Further, to support different radio access technologies, at least one of the baseband processor 14-20 or the RF processor 14-10 may include a plurality of communication modules. In addition, to process signals of different frequency bands, at least one of the baseband processor 14-20 or the RF processor 14-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz).

The storage 14-30 stores data such as basic programs, application programs, and configuration information for the operation of the UE. In particular, the storage 14-30 may store information for a second access node that performs wireless communication using a second radio access technology. The storage 14-30 provides stored data in response to a request from the controller 14-40.

The controller 14-40 controls the overall operation of the UE. For example, the controller 14-40 transmits and receives signals through the baseband processor 14-20 and the RF processor 14-10. Further, the controller 14-40 writes or reads data to or from the storage 14-30. To this end, the controller 14-40 may include at least one processor. For example, the controller 14-40 may include a communication processor (CP) for controlling communication and an application processor (AP) for controlling higher layers such as application programs.

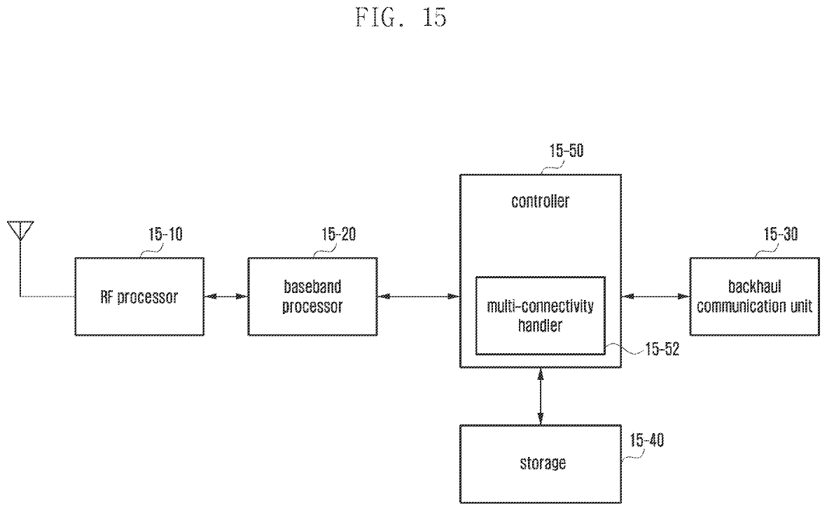

FIG. 15 is a block diagram showing the structure of a base station according to the disclosure.

As shown in the drawing, the base station includes an RF processor 15-10, a baseband processor 15-20, a backhaul communication unit 15-30, a storage 15-40, and a controller 15-50.

The RF processor 15-10 performs a function for transmitting and receiving a signal through a radio channel, such as signal band conversion and amplification. That is, the RF processor 15-10 performs up-conversion of a baseband signal provided from the baseband processor 15-20 into an RF-band signal and transmits the converted signal through an antenna, and performs down-conversion of an RF-band signal received through an antenna into a baseband signal. For example, the RF processor 15-10 may include a transmission filter, a reception filter, an amplifier, a mixer, an oscillator, a DAC, and an ADC. Although only one antenna is illustrated in the drawing, the first access node may be provided with a plurality of antennas. Additionally, the RF processor 15-10 may include a plurality of RF chains. Further, the RF processor 15-10 may perform beamforming. For beamforming, the RF processor 15-10 may adjust phases and amplitudes of individual signals transmitted and received through plural antennas or antenna elements. The RF processor may perform downlink MIMO operation by transmitting one or more layers.

The baseband processor 15-20 performs conversion between a baseband signal and a bit stream in accordance with the physical layer specification of a first radio access technology. For example, for data transmission, the baseband processor 15-20 generates complex symbols by encoding and modulating a transmission bit stream. Further, for data reception, the baseband processor 15-20 restores a reception bit stream by demodulating and decoding a baseband signal provided from the RF processor 15-10. For example, in the case of utilizing OFDM, for data transmission, the baseband processor 15-20 generates complex symbols by encoding and modulating a transmission bit stream, maps the complex symbols to subcarriers, and composes OFDM symbols through IFFT operation and CP insertion. Further, for data reception, the baseband processor 15-20 divides a baseband signal provided from the RF processor 15-10 in units of OFDM symbols, restores the signals mapped to subcarriers through FFT operation, and restores the reception bit stream through demodulation and decoding. The baseband processor 15-20 and the RF processor 15-10 transmits and receives signals as described above. Hence, the baseband processor 15-20 and the RF processor 15-10 may be called a transmitter, a receiver, a transceiver, a communication unit, or a wireless communication unit.

The backhaul communication unit 15-30 provides an interface for communication with other nodes in the network. That is, the backhaul communication unit 15-30 converts a bit stream, which is to be transmitted from the base station to another node, for example, a secondary base station or the core network, into a physical signal, and converts a physical signal received from another node into a bit stream.

The storage 15-40 stores data such as basic programs, application programs, and configuration information for the operation of the base station. In particular, the storage 15-40 may store information on a bearer allocated to a connected UE and measurement results reported from the connected UE. Further, the storage 15-40 may store information used as a criterion for determining whether to provide or suspend multi-connectivity to the UE. In addition, the storage 15-40 provides stored data in response to a request from the controller 15-50.

The controller 15-50 controls the overall operation of the base station. For example, the controller 15-50 transmits and receives signals through the baseband processor 15-20 and the RF processor 15-10 or through the backhaul communication unit 15-30. Further, the controller 15-50 writes or reads data to or from the storage 15-40. To this end, the controller 15-50 may include at least one processor.

1. A method performed by a terminal in a wireless communication system, the method comprising:
receiving, from a base station, a radio resource control (RRC) message including candidate configurations of target cells;
receiving, from the base station, a medium access control (MAC) control element (CE) for a handover;
performing the handover to a target cell associated with one of the candidate configurations indicated by the MAC CE; and
transmitting, to the base station, an RRC complete message indicating completion of the handover.

2. The method of claim 1, wherein the MAC CE further includes a transmission configuration indicator (TCI) state for the target cell.

3. The method of claim 1,
wherein the MAC CE further includes a field, and
wherein the field is used to determine whether to perform a random access channel (RACH) procedure for the target cell.

4. The method of claim 3, wherein the handover is completed in case that a random access procedure is successfully completed.

5. A method performed by a base station in a wireless communication system, the method comprising:
transmitting, to a terminal, a radio resource control (RRC) message including candidate configurations of target cells;
transmitting, to the terminal, a medium access control (MAC) control element (CE) for a handover; and
receiving, from the terminal, an RRC complete message indicating completion of the handover in case that the terminal is handed over to a target cell associated with one of the candidate configurations indicated by the MAC CE.

6. The method of claim 5, wherein the MAC CE further includes a transmission configuration indicator (TCI) state for the target cell.

7. The method of claim 5,
wherein the MAC CE further includes a field, and
wherein the field is used to determine whether to perform a random access channel (RACH) procedure for the target cell.

8. The method of claim 7, wherein the handover is completed in case that a random access procedure is successfully completed.

9. A terminal in a wireless communication system, comprising:
a transceiver; and
a controller coupled with the transceiver,
wherein the controller is configured to:
receive, from a base station, a radio resource control (RRC) message including candidate configurations of target cells,
receive, from the base station, a medium access control (MAC) control element (CE) for a handover,
perform the handover to a target cell associated with one of the candidate configurations indicated by the MAC CE, and
transmit, to the base station, an RRC complete message indicating completion of the handover.

10. The terminal of claim 9, wherein the MAC CE further includes a transmission configuration indicator (TCI) state for the target cell.

11. The terminal of claim 9,
wherein the MAC CE further includes a field, and
wherein the field is used to determine indicating-whether to perform a random access channel (RACH) procedure for the target cell.

12. The terminal of claim 11, wherein the handover is completed in case that a random access procedure is successfully completed.

13. A base station in a wireless communication system, comprising:
a transceiver; and
a controller coupled with the transceiver,
wherein the controller is configured to:
transmit, to a terminal, a radio resource control (RRC) message including candidate configurations of target cells,
transmit, to the terminal, a medium access control (MAC) control element (CE) for a handover, and
receive, from the terminal, an RRC complete message indicating completion of the handover in case that the terminal is handed over to a target cell associated with one of the candidate configurations indicated by the MAC CE.

14. The base station of claim 13, wherein the MAC CE further includes a transmission configuration indicator (TCI) state for the target cell.

15. The base station of claim 13,
wherein the handover is completed in case that a random access procedure is successfully completed,
wherein the MAC CE further includes a field, and
wherein the field is used to determine whether to perform a random access channel (RACH) procedure for the target cell.
